(19) United States
(12) Patent Application Publication
(10) Pub. No.: US 2017/0243112 A1
(43) Pub. Date: Aug. 24, 2017

(54) DEEP LEARNING APPROACH TO IDENTIFY COMPARATIVE REFERENCE INCIDENTS

(71) Applicant: International Business Machines Corporation, Armonk, NY (US)

(72) Inventors: Vijay Ekambaram, Tamilnadu (IN); Sarbajit K. Rakshit, Kolkata (IN)

(21) Appl. No.: 15/051,722

(22) Filed: Feb. 24, 2016

(51) Int. Cl. G06N 3/08; G06N 99/00

(52) U.S. Cl. CPC G06N 3/08; G06N 99/005

(57) ABSTRACT

A deep learning approach for comparative incident reference identification. An incident comparator receives descriptive texts including at least one past incidents, associated past features, selected incident and associated selected incident features. The descriptive texts are sent toward a text to vector engine. The incident comparator receives neural vectors associated to the descriptive texts and sends the neural vectors toward a learning engine. The incident comparator receives common features based on deep learning of the neural vectors. The neural vectors are plotted in N-D space based on the common features to create incident reference models. The incident comparator compares the selected incident and associated features with the incident reference models to identify and output comparative reference incidents.

### TECHNICAL FIELD

The present invention relates generally to context aware machine learning and more particularly, to identifying context/semantic related information of an incident based on unsupervised deep learning of past incidents of interest.

### BACKGROUND OF THE INVENTION

Incidents are events or occurrences that a person may experience. For example, a person may listen to a music genre, search some medical information or plan a journey. As incidents are identified, a person can benefit by comparing past incidents to better understand the current and/or planned incident. In a basic example, a person may be viewing artwork in a museum and they may want to search the artist's biography. In another example, a person may be travelling and may want to know of route detours, how far or how long it will take to reach a destination. Comparisons of past information can be performed on many features and can be useful if that information is of interest to a person. Features such as time and distance are fundamental aspects of a trip while ‘things to see’ usefulness varies based on a person's interests.

### SUMMARY

As disclosed herein, a method for a deep learning approach for comparative incident reference identification, the method comprising: receiving, by an incident comparator, one or more descriptive texts comprising at least one of a one or more past incidents, one or more past features associated with the one or more past incidents, selected incident and one or more selected incident features associated with the selected incident; sending, by the incident comparator, the one or more descriptive texts toward a text to vector engine; receiving, by the incident comparator, one or more neural vectors associated with the one or more descriptive texts; sending, by the incident comparator, the one or more neural vectors toward a learning engine; receiving, by the incident comparator, one or more common features based on deep learning of the one or more neural vectors; plotting, by the incident comparator, the one or more neural vectors in N-D space for at least one of the one or more common features, creating one or more incident reference models; comparing, by the incident comparator, the selected incident and the one or more selected incident features associated with the one or more incident reference models to identify one or more comparative reference incidents and outputting, by the incident comparator, the one or more comparative reference incidents. A computer system and a computer program product corresponding to the above method are also disclosed herein.

### BRIEF DESCRIPTION OF THE DRAWINGS

FIG. 1 is a functional block diagram illustrating a computing environment, in accordance with an embodiment of the present invention;

FIG. 2 is a flowchart depicting comparative reference incident identification flow, in accordance with an embodiment of the present invention;

FIG. 3A depicts a sample of neural vector conversion, in accordance with an embodiment of the present invention;

FIG. 3B depicts sample neural vector mappings of an incident, in accordance with an embodiment of the present invention; and

FIG. 4 depicts a block diagram of components of the server and/or the computing device, in accordance with an embodiment of the present invention.

### DETAILED DESCRIPTION

Embodiments of the present invention provide systems, methods, and computer program products for identifying context related information of an incident based on unsupervised deep learning. Deep learning (e.g., deep machine learning, deep structured learning, hierarchical learning) is a branch of machine learning based on a set of algorithms that attempt to model high-level abstractions in data.

Embodiments of the present invention can receive incident information from sources such as, but not limited to, mobile device applications and sensors. Text representations for incidents can be received as input from sensor and social network sources. The text representations can be transformed to neural vector representations (i.e., neural vectors) and those neural vectors can be processed using unsupervised deep learning to extract common features in context of each incident descriptive text string/representation. Neural vector of incidents enables the ability to identify similar incidents in various possible features/dimensions for a selected incident and features of interest. For each extracted common feature, the neural vectors representing an incident can be saved in multi-dimensional data models hereafter referred to as N-D space. An N-D space can be created for each common feature and each respective N-D space can be updated as incidents are received and processed. The N-D spaces become incident reference models used for comparing related incidents by common features.

Embodiments of the present invention can receive a user selection of a current and/or planned incident and compares the selected incident with past experience of a user and/or the user's social relationships. Reference information sources such as, but not limited to, social networking user feedback of similar incidents, user incident selection and sensor information can be received to produce neural vectors for incident and feature comparison.

Various features can be learned based on the selected incident descriptive text input and can be processed similar to the incident reference model creation process. The selected incident descriptive texts can be transformed to neural vectors and unsupervised deep learning techniques can be applied to determine similar and/or common features. The selected incident can be compared to N-D space(s) for each selected incident feature(s). Past similar incidents can be found based on Euclidean distance between the selected incident feature(s) to identify comparative reference incidents. A predetermined quantity or “top-K” similar incidents and features can be collected based on the shortest Euclidean distance (e.g., strongest relationship) between the user selected incident features and past/prior incident features to identify comparative reference incidents. The top-K comparative reference incident results data can be output based on each selected incident feature in a predetermined format and predetermined quantity based on implementation environment. For example, top five suggestions/output for a selected incident feature can be provided as data in a format such as, but not limited to, a plurality of text and/or numbers, positional references on a map, an interaction “word cloud” (i.e., word histogram) and one or more referential pointer (e.g., Uniform Resource Locator). It should be noted that Euclidean distance is the “ordinary” (i.e., straight-line) distance between two points in Euclidean space. Euclidean space encompasses the two-dimensional Euclidean plane in three-dimensional space of Euclidean geometry.

As previously described, embodiments of the present invention can use Euclidean distance measures of incident neural vectors as a basis to learn context related features of past incidents that can be of interest to a user for a current and/or planned incident. For example, a travel related incident comparison can comprise features such as, but not limited to, road condition, user health data, traffic congestion timing and climate adaptability. A comparison can comprise of incidents such as, but not limited to, the traveler's previous stay(s) for similar travel and can include features such as, but not limited to, available eateries comprising cuisine, price and rating. Comparative references described in the prior example can help a user understand features of an incident and more particularly, identifies incident features that are personalized to user interests. It should be noted that embodiments of the present invention can access social network information to analyze “friend” data, particularly when friend data closely matches an incident of interest. Embodiments of the present invention can distinguish incident sources used as comparative data by providing identifiers such as, but not limited to, an icon, a symbol and image. Further, embodiments of the present invention can summarize suggestions and recommendations for the current and/or planned incident, based on the interests/feature(s) selected by the user and/or social friend past similar incidents. It should be noted that social network incident corpus depth can extend from first level friends to a range of friends of a friend (foaf) levels depending on social network friend information sharing rules and common interest matches.

Embodiments of the present invention will now be described in detail with reference to the figures. It should be noted that references in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure or characteristic is described in connection with an embodiment, it is submitted that it is within the knowledge of one skilled in the art to affect such feature, structure or characteristic in connection with other embodiments whether or not explicitly described.

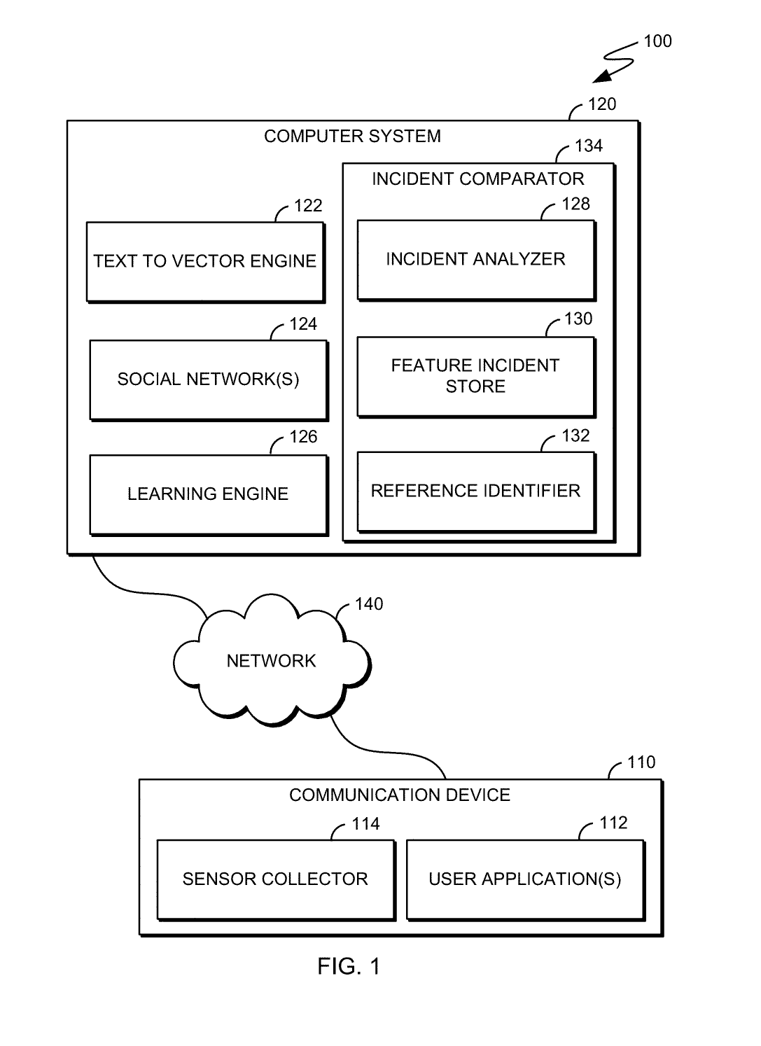

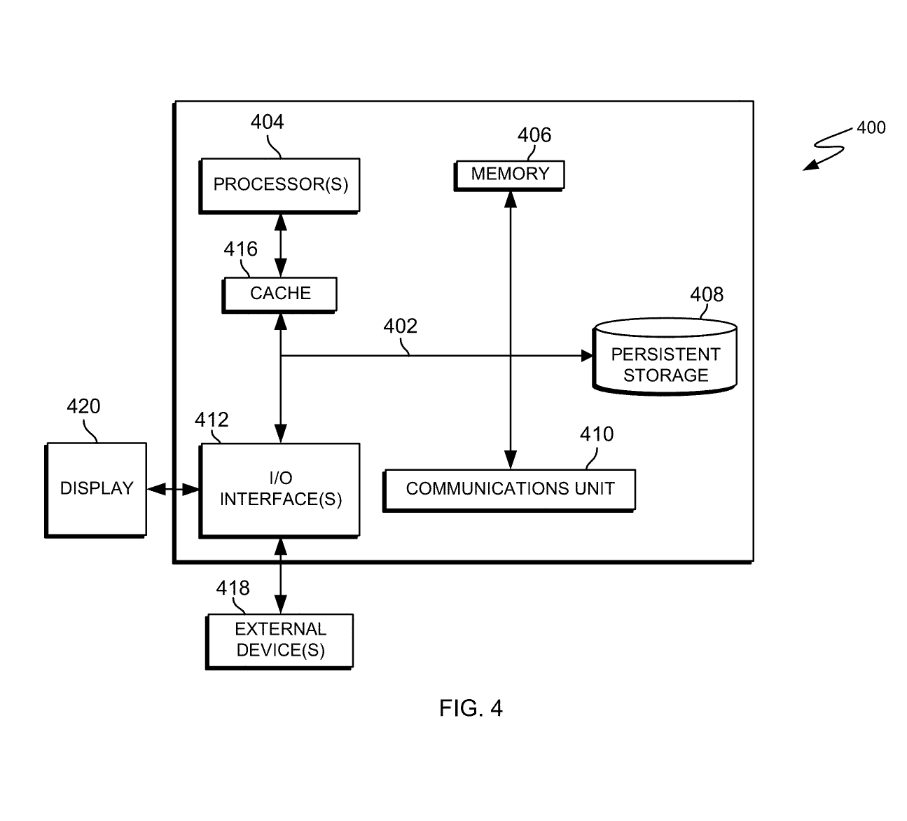

FIG. 1 is a functional block diagram of computing environment 100, in accordance with an embodiment of the present invention. Computing environment 100 comprises COMMUNICATION DEVICE 110, and COMPUTER SYSTEM 120, interconnected via NETWORK 140. COMMUNICATION DEVICE 110 and COMPUTER SYSTEM 120 can be desktop computers, laptop computers, specialized computer servers or the like. In certain embodiments, COMMUNICATION DEVICE 110 and COMPUTER SYSTEM 120 represent computer systems utilizing clustered computers and components acting as a single pool of seamless resources via NETWORK 140. For example, such embodiments can be used in data center, cloud computing, storage area network (SAN), and network attached storage (NAS) applications. In general, COMMUNICATION DEVICE 110 and COMPUTER SYSTEM 120 are representative of any electronic devices, or combination of electronic devices, capable of executing computer readable program instructions, as described in detail with regard to FIG. 4.

In one embodiment of the present invention, COMMUNICATION DEVICE 110 comprises USER APPLICATION(S) 112 and SENSOR COLLECTOR 114.

In one embodiment of the present invention, USER APPLICATION(S) 112 can be a plurality of USER APPLICATION(S) 112 within COMMUNICATION DEVICE 110. USER APPLICATION(S) 112 are tools that can interact with a user, sensors and functions of embodiments of the present invention to identify comparative reference incidents using unsupervised deep learning techniques. When USER APPLICATION(S) 112 receives one of a plurality of incidents, selected incidents, sensor information, user feedback, social network feedback and selected incident features, the resulting incident descriptive text can be sent toward INCIDENT ANALYZER 128. In embodiments of the present invention, USER APPLICATION(S) 112 comprises any combination of commercial or custom software products associated with operating and maintaining incident collection and user output.

In one embodiment of the present invention, SENSOR COLLECTOR 114 can be a plurality of SENSOR COLLECTORS 114 within COMMUNICATION DEVICE 110. SENSOR COLLECTOR 114 are devices that can interact with a physical environment. Sensors can comprise devices such as, but not limited to, global positional system (GPS), motion detectors, thermometers and radio sensor (e.g., Radio-Frequency Identification (RFID) detector). SENSOR COLLECTOR 114 can operate with USER APPLICATION(S) 112 and/or with INCIDENT ANALYZER 128 to detect a plurality of incidents and/or incident features. In embodiments of the present invention, SENSOR COLLECTOR 114 comprises any combination of commercial or custom devices and/or software products associated with incident and/or feature collection. It should be noted that embodiments of the present invention can operate with text representation of incident/features. The conversion of raw data from SENSOR COLLECTOR 114 into text format can be performed by embodiments of the present invention or preprocessed by other operations.

NETWORK 140 can be, for example, a local area network (LAN), a wide area network (WAN) such as the Internet, or a combination of the two, and include wired, wireless, or fiber optic connections. In general, NETWORK 140 can be any combination of connections and protocols that will support communications between COMMUNICATION DEVICE 110 and COMPUTER SYSTEM 120, in accordance with an embodiment of the present invention.

In one embodiment of the present invention, COMPUTER SYSTEM 120 comprises TEXT TO VECTOR ENGINE 122, SOCIAL NETWORK(S) 124, LEARNING ENGINE 126 and INCIDENT COMPARATOR 134. INCIDENT COMPARATOR 134 further comprises INCIDENT ANALYZER 128, FEATURE INCIDENT STORE 130 and REFERENCE IDENTIFIER 132. In other embodiments of the present invention, COMMUNICATION DEVICE 110 can comprise any combination of TEXT TO VECTOR ENGINE 122, SOCIAL NETWORK(S) 124, LEARNING ENGINE 126, INCIDENT COMPARATOR 134, INCIDENT ANALYZER 128, FEATURE INCIDENT STORE 130 and REFERENCE IDENTIFIER 132.

In one embodiment of the present invention, TEXT TO VECTOR ENGINE 122 can be a plurality of TEXT TO VECTOR ENGINES 122 within COMPUTER SYSTEM 120. TEXT TO VECTOR ENGINE 122 can be a tool to identify neural vectors for words associated with the incident descriptive text. Tools such as, but not limited to, Google Word2Vec can perform a weighted average to determine a neural vector for an incident. The neural vector is a compact data structure that can contextually identify semantics of an incident (e.g., vectors of similar incidents will be near each other). Vector representation for words in the incident descriptive text can be created and a weighted vector average can be used to determine the vector representation for the incident. In embodiments of the present invention, TEXT TO VECTOR ENGINE 122 comprises any combination of commercial or custom software products associated with operating and maintaining incident collection and user output. When TEXT TO VECTOR ENGINE 122 completes processing incident descriptive text, the resulting neural vector is sent toward INCIDENT ANALYZER 128.

In one embodiment of the present invention, SOCIAL NETWORK(S) 124 can be websites and applications to interact with users to find people with similar interests to oneself. SOCIAL NETWORK(S) 124 can be a source of incident and feature information for a user and friends of the user. Past incident information from SOCIAL NETWORK(S) 124 can be sent toward INCIDENT ANALYZER 128.

In one embodiment of the present invention, LEARNING ENGINE 126 can be a plurality of LEARNING ENGINES 126 within COMPUTER SYSTEM 120. LEARNING ENGINE 126 can be a deep learning processing function that receives neural vectors of incident to learn and extract common features. LEARNING ENGINE 126 can be based on neural probabilistic language model which understands the context of words and represent each word as a vector in N-D space. Using this technique, similar words have similar numeric value and can be plotted closer to each other in N-D space. In embodiments of the present invention, LEARNING ENGINE 126 comprises any combination of commercial or custom software products capable of extracting incident common features based on neural vectors. The common features can be sent toward INCIDENT ANALYZER 128.

It should be noted that INCIDENT COMPARATOR 134 function is described using comprising components INCIDENT ANALYZER 128, FEATURE INCIDENT STORE 130 and REFERENCE IDENTIFIER 132. INCIDENT COMPARATOR 134 comprises any combination of commercial or custom software products capable of operating deep learning to identify comparative reference incidents.

In one embodiment of the present invention, INCIDENT ANALYZER 128 can be a plurality of INCIDENT ANALYZERS 128 within COMPUTER SYSTEM 120. INCIDENT ANALYZER 128 can be a tool to receive incident descriptive text, manage processing of incidents to identify common features of incidents, plot neural embedded representations for each incident in N-D space based on each common/selected incident feature and sends N-D space results toward FEATURE INCIDENT STORE 130. In embodiments of the present invention, INCIDENT ANALYZER 128 comprises any combination of commercial or custom software products capable of analyzing incidents.

In one embodiment of the present invention, FEATURE INCIDENT STORE 130 can be a plurality of FEATURE INCIDENT STORES 130 within COMPUTER SYSTEM 120. FEATURE INCIDENT STORE 130 can be data store of a plurality of N-D space(s) comprising incidents where each N-D space can be represented by common feature determined by LEARNING ENGINE 126. FEATURE INCIDENT STORE 130 can be an information source REFERENCE IDENTIFIER 132.

In one embodiment of the present invention, REFERENCE IDENTIFIER 132 can be a plurality of REFERENCE IDENTIFIERS 132 within COMPUTER SYSTEM 120.

REFERENCE IDENTIFIER 132 can be a tool to receive a selected incident and a plurality of selected incident features. REFERENCE IDENTIFIER 132 receives FEATURE INCIDENT STORE 130 for each selected incident feature searches N-D space for top-K comparative reference incidents that have the closest Euclidean distance. The top-K comparative reference incidents for each selected incident feature can be sent toward COMMUNICATION DEVICE 110. In embodiments of the present invention, REFERENCE IDENTIFIER 132 comprises any combination of commercial or custom software products capable of identifying comparative reference incidents based on Euclidean distance comparison in N-D space. It should be noted that some embodiments of the present invention can use a predetermined threshold value to determine the quantity of top-K closest Euclidean distance.

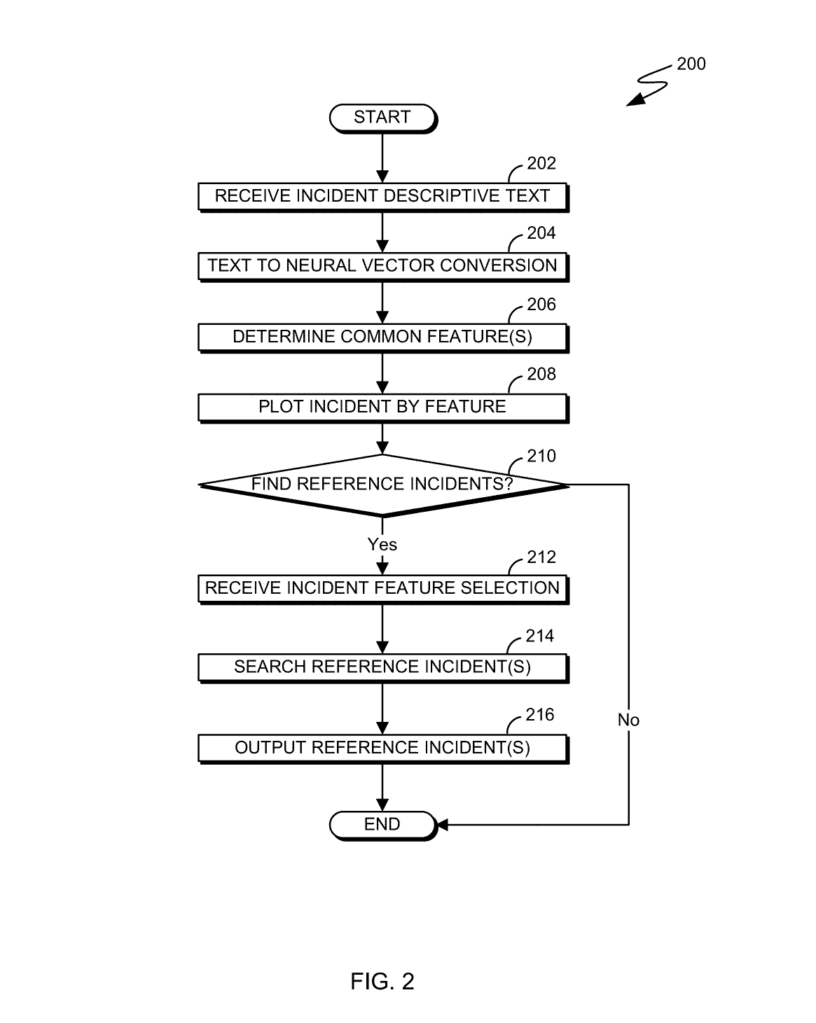

FIG. 2 is a flowchart depicting comparative reference incident identification flow, in accordance with an embodiment of the present invention. Step 202 RECEIVE INCIDENT FEATURES in flow diagram 200 comparative reference incident flow, receives incident descriptive text describing an incident from COMMUNICATION DEVICE 110. Incident descriptive text can include information, such as, but not limited to, mobile phone mobility pattern, road condition, social network postings and user's health. Embodiments of the present invention provides for input to be received from sensors connected and/or installed in a user device and can be collected automatically and/or from user input. The incident descriptive text input can be in any predetermined language that can be processed by TEXT TO VECTOR ENGINE 122. The incident descriptive text can be sent toward step 204 TEXT TO NEURAL VECTOR CONVERSION.

In step 204 TEXT TO NEURAL VECTOR CONVERSION the incident descriptive text are neural vectors. For example, a tool such as, but not limited to, Google Word2Vec can be used to process and transform the incident descriptive text to neural vectors. The neural vectors can be sent toward step 206 DETERMINE COMMON FEATURE(S).

In step 206 DETERMINE COMMON FEATURE(S) the collected incident descriptive text is processed by unsupervised deep learning algorithms to extract incident features and identify common (i.e., shared) incident features for past incidents. In some embodiments of the present invention, the common features can be predetermined by user input and incident neural vectors values having similar values can be used to learn common features of each incident processed. In other embodiments of the present invention, common features can be learned based on comparisons of the incident reference model neural vectors to find dominant feature words as incident reference models develop. An aspect of determining common features can use weighted averages to create neural vectors comprising each common feature as a primary word. An example of determining common features follows: Given incident (T1) from a social network feedback, “I enjoyed my trip to Venice and while it was a hot July, I still enjoyed an espresso at Piazza San Marco.” From incident (T1), common features such as location (e.g., Venice, Piazza San Marco), climate (e.g., hot) and food (e.g., espresso) can be extracted from the incident descriptive text. In this example, three corresponding neural vectors for incident (T1) (not shown) can be extracted based on the three learned common features based on unsupervised deep learning. In this example, each of the three neural vectors are extracted based on weighting of each common feature associate to incident (T1). Incident (T1) comprises n words (e.g., w₁, w₂, wₙ). For the review of incident (rᵢ) each word in incident (T1) is converted to a neural vector (e.g., vector(w₁), vector(w₂), vector(wₙ)). For common feature “climate”, incident review weighting formula is applied as rᵢ=Σⱼ₌₁ⁿ(weightⱼ*vector(wⱼ). Review formula, rᵢ is calculated where word vectors vector(wj) similar to the common feature “climate” have a weightⱼ greater than where vector(wj) is not similar to common feature “climate” (e.g., j ranges from 0 to 1). For each common feature, neural embedded representations can be extracted based on the weighted incidents. It should be noted that the former incident weighting example is one of a plurality of weighting technique available to one skilled in the art and embodiments of the present invention can use alternate incident weighting approaches. The incident neural embedded representations can be sent toward step 208 PLOT INCIDENT BY FEATURE.

In step 208 PLOT INCIDENT BY FEATURE, neural embedded representations for each incident are plotted in N-D space based on each common/selected incident feature. The plotted incidents establish an incident reference model by common feature and provides proximity orientation of similar incidents with respect to a common feature (e.g., climate) in N-D space. It should be noted that the term ‘plot’ represents a mathematical data model upon which a graphical representation in N-D space can be displayed. A graphical display is used in this document for convenience of description and is one of many possible outputs. It should be further noted that the storage format of the N-D space analytic data model is based on possible implementations.

In step 210 FIND REFERENCE INCIDENT is a logical operation fork. If an incident is received and a user is not executing a comparison to past incidents then the received incident will be processed as an entry into an incident reference model and the process ends until a next incident starts 200 comparative reference incident flow. When step 210 FIND REFERENCE INCIDENT is true based on a user selection of a current and/or planned incident, then the selected incident is sent toward step 212 RECEIVE INCIDENT FEATURE SELECTION.

In step 212 RECEIVE INCIDENT FEATURE SELECTION, a selected common feature is received and used for searching related past incidents. In an embodiment of the present invention, a predetermined list of common features can be selected by a user based the available reference models and/or predetermined user preferences. In another embodiment of the present invention, USER APPLICATION(S) 112 can request additional input about features of interest from a user where other embodiments of the present invention can comprise one or more combinations of predetermined features, user input, social network information and sensors on and/or connected to a mobile device can be used to select incident features to be searched.

In step 214 SEARCH REFERENCE INCIDENT(S), the neural vector of the selected incident is compared to each existing incident reference model based on each associated selected incident feature. For each selected incident feature top-K, similar incidents are identified based on closest Euclidean distance. For example, the selected incident feature can be climate, the selected incident as plotted in the climate feature incident reference model, is compared to top-K similar incidents and are identified based on closest Euclidean distance. The resulting top-K similar incidents are sent toward step 216 OUTPUT REFERENCE INCIDENT(S).

In step 216 OUTPUT REFERENCE INCIDENT(S), resulting top-K comparative reference incident data can be output based on each selected incident feature in a predetermined format based on implementation environment. The comparative reference incidents for the selected incident feature (e.g., feature of interest) can be output for user reference and embodiments of the present invention provide for indicators where past incidents can be based on social network friend experience. The comparative reference incident indicators can be a mark such as, but not limited to, icon, picture and text to identify the incident source. Top-K comparative reference incident output can be filtered further based on a predetermined value such as, but not limited to, a defined number, number of features to display and proximity to incident feature. For example, a user selected incident can be museum related and while moving toward a suggested art collection and passing a cafeteria in the museum, a past incident based on a user's dining preferences could be filtered to this location and filter additional near-by top-K alternatives given the venue. Comparative reference incident output can be provided as data in a format such as, but not limited to, text list(s), positional references on a map, interaction “word cloud” (i.e., word histogram) and Uniform Resource Locators (URL).

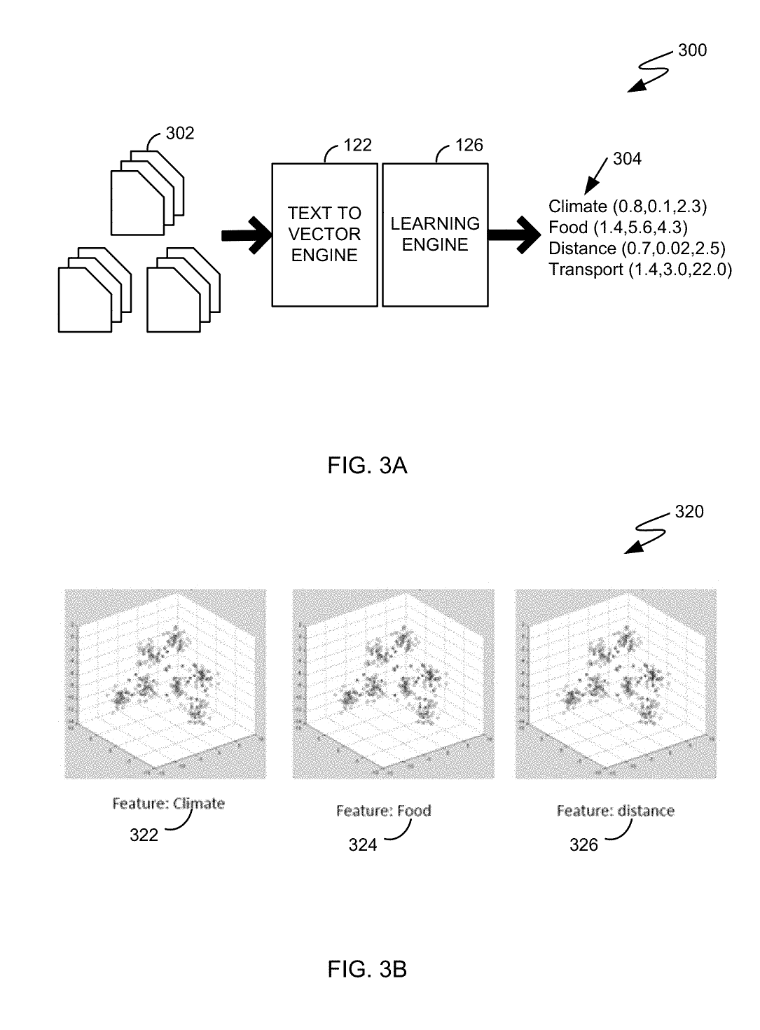

FIG. 3A depicts a sample of neural vector conversion, in accordance with an embodiment of the present invention. Incident analysis 300 comprises item 302 representative incident descriptive texts, TEXT TO VECTOR ENGINE 122, LEARNING ENGINE 126 and item 304 resultant neural vector.

Item 302 representative incident descriptive texts are received by TEXT TO VECTOR ENGINE 122. Each word in an incident descriptive text string is transformed to a neural vector and the neural vector of each incident is sent toward INCIDENT ANALYZER 128 (not shown). INCIDENT ANALYZER 128 sends each incident neural vector toward LEARNING ENGINE 126. LEARNING ENGINE 126 analyzes the incident neural vector to find dominant word vectors and uses close Euclidean distance to determine common feature matches. For example, a common feature in a reference model can be “Climate.” Words such as, but not limited to, “overcast”, “sunny” and “balmy” features are “learned” to be closely related to “climate” and therefore the common feature of “climate” is used for neural vector inclusion in the “climate” reference model by LEARNING ENGINE 126.

Item 304 resultant neural vector comprise Climate (0.8,0.1,2.3); Food (1.4,5.6,4.3); Distance (0.7,0.02,2.5) and Transport (1.4,3.0,22.0). In this example, Climate, Food, Distance and Transport have been identified by LEARNING ENGINE 126 as common features of respective incident neural vector values encompassed in parentheses. The neural vector value in parentheses represents the neural vector value of each word in incident descriptive text that is plotted in N-D space reference models. It should be noted that the example common features, “Climate”, “Food”, “Distance” and “Transport”, can be the same incident where a weighted average is applied based on each common feature in preparation of neural vector mapping.

FIG. 3B depicts sample neural vector mappings of an incident, in accordance with an embodiment of the present invention. N-D space reference models 320 depicts N-D space graphical representations of common features: item 322 climate, item 324 food and item 326 distance.

With reference to item 304 resultant neural vector “Climate (0.8,0.1,2.3)”, item 322 climate can contain values “0.8,0.1,2.3” in N-D space for an incident. Likewise, the same incident can be represented in item 324 food and item 326 distance if the incident comprises incident descriptive text with common features of food and distance. When a current and/or planned incident is selected by a user and a common feature of interest is selected (e.g., climate) then reference model item 322 climate is compared by REFERENCE IDENTIFIER 132 to find comparative reference incident having close Euclidian distance. It is shown in item 322 climate that there are various clustering of incident neural vectors. As the selected incident neural vector values are compared to past incident neural vector values, the strongest Top-K past incidents are extracted from N-D space as comparative reference incidents.

FIG. 4 depicts a block diagram of components of COMMUNICATION DEVICE 110 and COMPUTER SYSTEM 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for a deep learning approach for comparative incident reference identification, the method comprising:
receiving, by an incident comparator, one or more descriptive texts comprising at least one of a one or more past incidents, one or more past features associated with the one or more past incidents, selected incident and one or more selected incident features associated with the selected incident;
sending, by the incident comparator, the one or more descriptive texts toward a text to vector engine;
receiving, by the incident comparator, one or more neural vectors associated with the one or more descriptive texts;
sending, by the incident comparator, the one or more neural vectors toward a learning engine;
receiving, by the incident comparator, one or more common features based on deep learning of the one or more neural vectors;
plotting, by the incident comparator, the one or more neural vectors in N-D space for at least one of the one or more common features, creating one or more incident reference models;
comparing, by the incident comparator, the selected incident and the one or more selected incident features associated with the one or more incident reference models to identify one or more comparative reference incidents; and
outputting, by the incident comparator, the one or more comparative reference incidents.

2. The method of claim 1, wherein the one or more descriptive texts are based on receiving input from at least one of one or more mobile devices, one or more connected sensors and one or more social network sources.

3. The method of claim 2, wherein the one or more social network sources comprises feedback of at least one of a user, one or more social network friends and one or more social network friends of a friend.

4. The method of claim 1, wherein outputting the one or more comparative reference incidents comprises data in a format of at least one of one or more text, one or more numeric value, one or more positional references and one or more referential pointers.

5. The method of claim 1, wherein the one or more comparative reference incidents are filtered based on at least one of a strongest relationship threshold, the one or more selected incident features and a proximity to incident feature.

6. The method of claim 1, wherein outputting the one or more comparative reference incidents comprises at least one of an identifier of one or more incident sources distinguishing at least one of a user, a one or more social network friends and a one or more social network friends of a friend.

7. The method of claim 1, wherein outputting the one or more comparative reference incidents are filtered based on at least one of a predetermined quantity, a number of features to display, the one or more selected incident features and a proximity to an incident feature.

8. A computer program product for a deep learning approach for comparative incident reference identification, the computer program product comprising:
one or more computer readable storage media and program instructions stored on the one or more computer readable storage media, the program instructions comprising:
program instructions to, receive, by an incident comparator, one or more descriptive texts comprising at least one of a one or more past incidents, one or more past features associated with the one or more past incidents, selected incident and one or more selected incident features associated with the selected incident;
program instructions to, send, by the incident comparator, the one or more descriptive texts toward a text to vector engine;
program instructions to, receive, by the incident comparator, one or more neural vectors associated with the one or more descriptive texts;
program instructions to, send, by the incident comparator, the one or more neural vectors toward a learning engine;
program instructions to, receive, by the incident comparator, one or more common features based on deep learning of the one or more neural vectors;
program instructions to, plot, by the incident comparator, the one or more neural vectors in N-D space for at least one of the one or more common features, creating one or more incident reference models;
program instructions to, compare, by the incident comparator, the selected incident and the one or more selected incident features associated with the one or more incident reference models to identify one or more comparative reference incidents; and
program instructions to, output, by the incident comparator, the one or more comparative reference incidents.

9. The computer program product of claim 8, wherein the one or more descriptive texts are based on receiving input from at least one of one or more mobile devices, one or more connected sensors and one or more social network sources.

10. The computer program product of claim 9, wherein the one or more social network sources comprises feedback of at least one of a user, one or more social network friends and one or more social network friends of a friend.

11. The computer program product of claim 8, wherein outputting the one or more comparative reference incidents comprises data in a format of at least one of one or more text, one or more numeric value, one or more positional references and one or more referential pointers.

12. The computer program product of claim 8, wherein the one or more comparative reference incidents are filtered based on at least one of a strongest relationship threshold, the one or more selected incident features and a proximity to incident feature.

13. The computer program product of claim 8, wherein outputting the one or more comparative reference incidents comprises at least one of an identifier of one or more incident sources distinguishing at least one of a user, a one or more social network friends and a one or more social network friends of a friend.

14. The computer program product of claim 8, wherein outputting the one or more comparative reference incidents are filtered based on at least one of a predetermined quantity, a number of features to display, the one or more selected incident features and a proximity to an incident feature.

15. A computer system for a deep learning approach for comparative incident reference identification, the computer system comprising:
one or more computer processors;
one or more computer readable storage media;
program instructions stored on the one or more computer readable storage media for execution by at least one of the one or more computer processors, the program instructions comprising:
program instructions to, receive, by an incident comparator, one or more descriptive texts comprising at least one of a one or more past incidents, one or more past features associated with the one or more past incidents, selected incident and one or more selected incident features associated with the selected incident;
program instructions to, send, by the incident comparator, the one or more descriptive texts toward a text to vector engine;
program instructions to, receive, by the incident comparator, one or more neural vectors associated with the one or more descriptive texts;
program instructions to, send, by the incident comparator, the one or more neural vectors toward a learning engine;
program instructions to, receive, by the incident comparator, one or more common features based on deep learning of the one or more neural vectors;
program instructions to, plot, by the incident comparator, the one or more neural vectors in N-D space for at least one of the one or more common features, creating one or more incident reference models;
program instructions to, compare, by the incident comparator, the selected incident and the one or more selected incident features associated with the one or more incident reference models to identify one or more comparative reference incidents; and
program instructions to, output, by the incident comparator, the one or more comparative reference incidents.

16. The computer system of claim 15, wherein the one or more descriptive texts are based on receiving input from at least one of one or more mobile devices, one or more connected sensors and one or more social network sources.

17. The computer system of claim 16, wherein the one or more social network sources comprises feedback of at least one of a user, one or more social network friends and one or more social network friends of a friend.

18. The computer system of claim 15, wherein outputting the one or more comparative reference incidents comprises data in a format of at least one of one or more text, one or more numeric value, one or more positional references and one or more referential pointers.

19. The computer system of claim 15, wherein the one or more comparative reference incidents are filtered based on at least one of a strongest relationship threshold, the one or more selected incident features and a proximity to incident feature.

20. The computer system of claim 15, wherein outputting the one or more comparative reference incidents comprises at least one of an identifier of one or more incident sources distinguishing at least one of a user, a one or more social network friends and a one or more social network friends of a friend.
